(19) United States
(12) Patent Application Publication
(10) Pub. No.: US 2024/0403132 A1
(43) Pub. Date: Dec. 5, 2024

(54) CONFIDENTIAL GRID COMPUTING

(71) Applicant: INTERNATIONAL BUSINESS MACHINES CORPORATION, ARMONK, NY (US)

(72) Inventors: Marcel Mitran, Markham (CA); Elton de Souza, Scarborough (CA)

(21) Appl. No.: 18/327,443

(22) Filed: Jun. 1, 2023

(51) Int. Cl. G06F 9/50; G06F 9/455; G06F 21/53

(52) U.S. Cl. CPC G06F 9/5072; G06F 9/45558; G06F 21/53; G06F 2009/45591

(57) ABSTRACT

Described are techniques for confidential grid computing such as system including a confidential computing provider comprising a geographically dispersed grid of nodes implemented in a trusted execution environment. The system further includes a plurality of compute consumers including a first compute consumer comprising a workload configured to run on a cloud computing environment, a Service Level Agreement (SLA), and a cost. The system further includes an orchestration manager communicatively coupling the confidential computing provider with the plurality of compute consumers, where the orchestration manager is configured to deploy the workload of the first compute consumer on at least one node of the confidential computing provider that satisfies at least the SLA and the cost.

### BACKGROUND

The present disclosure relates to distributed computing, and, more specifically, to confidential grid computing.

Grid computing refers to the utilization of widely distributed computer resources to implement one or more computational tasks. Grid computational resources are commonly aggregated from geographically dispersed and heterogeneous computers.

There is a significant amount of unused hardware resources deployed in datacenters around the world. However, there are also limitations on newly installed hardware resources due to supply chain disruptions and shortages. As a result, there is a need to harvest the unused hardware resources deployed in datacenters to meet growing compute demand without requiring additional hardware.

However, existing grid computing protocols do not offer adequate security and/or confidentiality for consumers. Additionally, existing grid computing protocols do not offer guaranteed protection/isolation nor technical liability protection for the provider of the vended compute resources.

### SUMMARY

Aspects of the present disclosure are directed toward a system including a confidential computing provider comprising a geographically dispersed grid of nodes implemented in a trusted execution environment. The system further includes a plurality of compute consumers including a first compute consumer comprising a workload configured to run on a cloud computing environment, a Service Level Agreement (SLA), and a cost. The system further includes an orchestration manager communicatively coupling the confidential computing provider with the plurality of compute consumers, where the orchestration manager is configured to deploy the workload of the first compute consumer on at least one node of the confidential computing provider that satisfies at least the SLA and the cost.

Additional aspects of the present disclosure are directed toward a computer-implemented method including deploying a Trusted Execution Environment comprising a plurality of nodes in a distributed multi-party grid infrastructure and configured to provide self-serve compute infrastructure for secure and confidential workload execution. The method further includes receiving a workload configured to run on a cloud computing environment, a Service Level Agreement (SLA) defining resource characteristics associated with execution of the workload, and a cost associated with executing the workload. The method further includes matching the workload to at least one node of the plurality of nodes satisfying the SLA and the cost. The method further includes executing the workload on the at least one node of the plurality of nodes.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example distributed multi-party grid infrastructure configured to provide self-serve compute infrastructure for secure and confidential workload execution, in accordance with some embodiments of the present disclosure.

FIG. 2 illustrates a diagram of interactions between various components of the distributed multi-party grid infrastructure, in accordance with some embodiments of the present disclosure.

FIG. 3 illustrates a flowchart of an example method for confidential grid computing, in accordance with some embodiments of the present disclosure.

FIG. 4 illustrates a flowchart of an example method for matching a workload to at least one node in a confidential grid computing environment, in accordance with some embodiments of the present disclosure.

FIG. 5 illustrates a flowchart of an example method for a provider to utilize confidential grid computing, in accordance with some embodiments of the present disclosure.

FIG. 6 illustrates a flowchart of an example method for an orchestration manager to utilize confidential grid computing, in accordance with some embodiments of the present disclosure.

FIG. 7 illustrates a flowchart of an example method for a compute consumer to utilize confidential grid computing, in accordance with some embodiments of the present disclosure.

FIG. 8 illustrates a flowchart of an example method for downloading, deploying, metering, and billing usage of confidential grid computing code, in accordance with some embodiments of the present disclosure.

FIG. 9 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward distributed computing, and, more specifically, to confidential grid computing. While not limited to such applications, embodiments of the present disclosure may be better understood in light of the aforementioned context.

Various aspects of the present disclosure include the following. Example 1 is a system comprising: a confidential computing provider 128 comprising a geographically dispersed grid of nodes 134 implemented in a trusted execution environment 130. The system further includes a plurality of compute consumers 102 including a first compute consumer 102-1 comprising a workload 112-1 configured to run on a cloud computing environment, a Service Level Agreement (SLA) 106-1, and a cost 108-1. The system further includes an orchestration manager 114 communicatively coupling the confidential computing provider 128 with the plurality of compute consumers 102, where the orchestration manager 114 is configured to deploy the workload 112-1 of the first compute consumer 102-1 on at least one node 134-1 of the confidential computing provider 128 that satisfies at least the SLA 106-1 and the cost 108-1.

Advantageously, Example 1 provides secure, confidential, economically efficient, and environmentally sustainable vendable compute resources.

Example 2 includes the features of Example 1. In this example, respective nodes 134 of the geographically dispersed grid of nodes 134 are individually untrusted, and where the workload 112-1 is securely deployed on the at least one node 134-1 of the confidential computing provider 128 using the trusted execution environment 130.

Advantageously, Example 2 utilizes the trusted execution environment 130 to provide a secure substrate for confidential computing using otherwise individually untrusted nodes.

Example 3 includes the features of any one of Examples 1 to 2. In this example, the trusted execution environment 130 is implemented at least in part by one or more Secure Services Containers (SSCs).

Advantageously, Example 3 utilizes one or more SSCs to at least partially implement the trusted execution environment 130. SSCs are interoperable with IBM Z® servers and IBM LinuxONE servers, among others, thereby providing an off-the-shelf framework to readily incorporate a secure substrate for confidential computing onto the geographically dispersed grid of nodes 134.

Example 4 includes the features of any one of Examples 1 to 3. In this example, the vendable compute resources provided by the geographically dispersed grid of nodes 134 are protected in-flight, at-rest, and in-use by the trusted execution environment.

Advantageously, Example 4 protects the vendable compute resources at all stages including in-flight (e.g., during transmission), at-rest (e.g., in storage), and in-use (e.g., when consumed to implement a workload). As a result, Example 4 provides comprehensive end-to-end data security.

Example 5 includes the features of any one of Examples 1 to 4. In this example, the trusted execution environment 130 further comprises Trusted Platform Module (TPM) attestation protocols implemented amongst the geographically dispersed grid of nodes 134.

Advantageously, Example 5 layers additional security into the geographically dispersed grid of nodes 134 by utilizing TPM attestation protocols. TPM attestation protocols can ensure the integrity of the dispersed grid of nodes 134, thereby hardening the system against cyberattacks.

Example 6 includes the features of any one of Examples 1 to 5. In this example, the orchestration manager 114 further comprises one or more computer-readable storage media collectively storing computer-executable program code configured to cause the orchestration manager 114 to: identify 402 a subset 126 of the geographically dispersed grid of nodes 134 satisfying the SLA 106-1; execute 404 a competitive selection engine 124 amongst the subset 126 of the geographically dispersed grid of nodes 134 and based on the cost 106-1; and select 406 one of the subset 126 of the geographically dispersed grid of nodes 134 based on the competitive selection engine 124.

Advantageously, Example 6 provides an efficient mechanism to identify at least one node 134 for implementing a workload 112 by utilizing the competitive selection engine 124 to select the most economically competitive node 134 that satisfies the SLA 106-1.

Example 7 includes the features of Example 6. In this example, the orchestration manager 114 comprises additional computer-executable program code stored in the one or more computer-readable storage media and configured to cause the orchestration manager 114 to: meter 408 the selected one of the subset 126 of the geographically dispersed grid of nodes 134; and verify 410 whether the selected one of the subset 126 of the geographically dispersed grid of nodes 134 satisfies the SLA 106-1 based on the metering 408.

Advantageously, Example 7 verifies whether the selected node does, in fact, satisfy the SLA 106-1 by metering the vendable resources of the selected node. In this way, Example 7 ensures that published characteristics of the selected node are accurate prior to implementing a workload 112 on the selected node.

Example 8 includes the features of Example 7. In this example, the orchestration manager 114 comprises additional computer-executable program code stored in the one or more computer-readable storage media and configured to cause the orchestration manager 114 to: determine (410: YES) that the selected one of the subset 126 of the geographically dispersed grid of nodes 134 satisfies the SLA 106-1 based on the metering 408; and automatically deploy 412 the workload 112-1 on the selected one of the subset 126 of the geographically dispersed grid of nodes 134.

Advantageously Example 8 automatically deploys the workload 112-1 on the selected node following verification that the selected node satisfies the SLA 106-1. In this way, the deployment of the workload 112-1 appears seamless to the first compute consumer 102-1.

Example 9 includes the features of Example 7. In this example, the orchestration manager 114 comprises additional computer-executable program code stored in the one or more computer-readable storage media and configured to cause the orchestration manager 114 to: determine (410: NO) that the selected one of the subset 126 of the geographically dispersed grid of nodes 134 fails to satisfy the SLA 106-1 based on the metering 408; deselect 414 the selected one of the subset 126 of the geographically dispersed grid of nodes 134; and select 416 another one of the subset 126 of the geographically dispersed grid of nodes 134.

Advantageously, Example 9 automatically selects a new node following failure of the originally selected node to satisfy the SLA 106-1. In this way, Example 9 prevents deployment of the workload on an inaccurately characterized node (e.g., although the originally selected node satisfies the SLA 106-1 according to published characteristics of the originally selected node, these aspects of the disclosure automatically verify the published characteristics of the originally selected node prior to deploying the workload 112-1 on the originally selected node).

Example 10 is a computer-implemented method. The computer-implemented method includes deploying 302 a Trusted Execution Environment 130 comprising a plurality of nodes 134 in a distributed multi-party grid infrastructure 100 and configured to provide self-serve compute infrastructure for secure and confidential workload execution. The method further includes receiving 304 a workload 112-1 configured to run on a cloud computing environment, a Service Level Agreement (SLA) 106-1 defining resource characteristics associated with execution of the workload 112-1, and a cost 108-1 associated with executing the workload 112-1. The method further includes matching 308 the workload 112-1 to at least one node 134-1 of the plurality of nodes 134 satisfying the SLA 106-1 and the cost 108-1. The method further includes executing 310 the workload 112-1 on the at least one node 134-1 of the plurality of nodes 134.

Advantageously, Example 10 provides secure, confidential, economically efficient, and environmentally sustainable vendable compute resources.

Example 11 includes the features of Example 10. In this example, respective nodes of the plurality of nodes 134 are individually untrusted, and the workload 112-1 is securely deployed on the at least one node 134-1 using the trusted execution environment 130.

Advantageously, Example 11 utilizes the trusted execution environment 130 to provide a secure substrate for confidential computing using otherwise individually untrusted nodes.

Example 12 includes the features of any one of Examples 10 to 11. In this example, the trusted execution environment 130 is implemented at least in part by one or more Secure Services Containers (SSCs).

Advantageously, Example 12 utilizes one or more SSCs to at least partially implement the trusted execution environment 130. SSCs are interoperable with IBM Z® servers and IBM LinuxONE servers, among others, thereby providing an off-the-shelf framework to readily incorporate a secure substrate for confidential computing onto the plurality of nodes 134.

Example 13 includes the features of any one of Examples 10 to 12. In this example, the vendable compute resources provided by the plurality of nodes 134 are protected in-flight, at-rest, and in-use by the trusted execution environment 130.

Advantageously, Example 13 protects the vendable compute resources at all stages including in-flight (e.g., during transmission), at-rest (e.g., in storage), and in-use (e.g., when consumed to implement a workload). As a result, Example 13 provides comprehensive end-to-end data security.

Example 14 includes the features of any one of Examples 10 to 13. In this example, the trusted execution environment 130 further comprises Trusted Platform Module (TPM) attestation protocols implemented amongst the plurality of nodes 134.

Advantageously, Example 14 layers additional security into the plurality of nodes 134 by utilizing TPM attestation protocols. TPM attestation protocols can ensure the integrity of the plurality of nodes 134, thereby hardening the system against cyberattacks.

Example 15 includes the features of any one of Examples 10 to 14. In this example, matching the workload 112-1 to the at least one node 134-1 of the plurality of nodes 134 further comprises: identifying 402 a subset 126 of the plurality of nodes 134 satisfying the SLA 106-1; executing 404 a competitive selection engine 124 amongst the subset 126 of the plurality of nodes 134 and based on the cost 108-1; and selecting 406 one of the subset 126 of the plurality of nodes 134 based on the competitive selection engine 124.

Advantageously, Example 15 provides an efficient mechanism to identify at least one node for implementing a workload 112-1 by utilizing the competitive selection engine 124 to select the most economically competitive node that satisfies the SLA 106-1.

Example 16 includes the features of Example 15. In this example, matching the workload 112-1 to the at least one node 134-1 of the plurality of nodes 134 further comprises: metering 408 the selected one of the subset 126 of the plurality of nodes 134; and verifying 410 whether the selected one of the subset 126 of the plurality of nodes 134 satisfies the SLA 106-1 based on the metering 408.

Advantageously, Example 16 verifies whether the selected node does, in fact, satisfy the SLA 106-1 by metering the vendable resources of the selected node. In this way, Example 16 ensures that published characteristics of the selected node are accurate prior to implementing a workload 112-1 on the selected node.

Example 17 includes the features of Example 16. In this example, matching the workload 112-1 to the at least one node 134-1 of the plurality of nodes 134 further comprises: determining (410: YES) that the selected one of the subset 126 of the plurality of nodes 134 satisfies the SLA 106-1 based on the metering 408; and automatically deploying 412 the workload 112-1 on the selected one of the subset 126 of the plurality of nodes 134.

Advantageously Example 17 automatically deploys the workload on the selected node following verification that the selected node satisfies the SLA 106-1. In this way, the deployment of the workload 112-1 appears seamless to the first compute consumer 102-1.

Example 18 includes the features of Example 16. In this example, matching the workload 112-1 to the at least one node 134-1 of the plurality of nodes 134 further comprises: determining (410: NO) that the selected one of the plurality of nodes 134 fails to satisfy the SLA 106-1 based on the metering 408; deselecting 414 the selected one of the subset 126 of the plurality of nodes 134; and selecting 416 a new one of the subset 126 of the plurality of nodes 134.

Advantageously, Example 18 automatically selects a new node following failure of the originally selected node to satisfy the SLA 106-1. In this way, Example 18 prevents deployment of the workload 112-1 on an inaccurately characterized node (e.g., although the originally selected node satisfies the SLA 106-1 according to published characteristics of the originally selected node, these aspects of the present disclosure automatically verify the published characteristics of the originally selected node prior to deploying the workload 112-1 on the originally selected node).

Example 19 includes the features of any one of Examples 10 to 18. In this example, the method is executed by one or more data processing systems based on computer-readable program code downloaded to the one or more data processing systems from a remote data processing system, and wherein the method further comprises: metering 806 usage of the computer-readable program code; and generating 808 an invoice based on metering the usage of the computer-readable program code.

Advantageously, example 19 provides a framework for delivering aspects of the present disclosure as a service, thereby enabling streamlined configuration and implementation of aspects of the present disclosure by various users with various use-cases.

Example 20 is a computer program product. The computer program product comprises one or more computer readable storage media, and program instructions collectively stored on the one or more computer readable storage media, the program instructions comprising instructions configured to cause one or more processors to perform a method according to any one of Examples 10 to 19. Likewise, Example 20 can realize any of the advantages discussed above with respect to Examples 10 to 19.

Example 21 is a system. The system includes one or more processors and one or more computer readable storage media collectively storing program instructions. The program instructions are configured to cause the one or more processors to perform a method according to any one of Examples 10 to 19. Likewise, Example 21 can realize any of the advantages discussed above with respect to Examples 10 to 19.

In summary, aspects of the present disclosure enable inclusion of Trusted Execution Environment (TEE) nodes in a globally distributed multi-party grid infrastructure to create a self-serve compute infrastructure marketplace for secure, confidential, economically, and environmentally sustainable workload execution. Some embodiments can include bidding capabilities for best-price/highest-profit deployment schemes.

To realize these aspects of the present disclosure, a TEE such as Secure Services Containers (a product of IBM) can be used to implement a substrate for confidential computing. Additionally, providers can be connected to a common grid by direct and/or indirect network access. Finally, workloads can be defined as source code or pre-built artifacts.

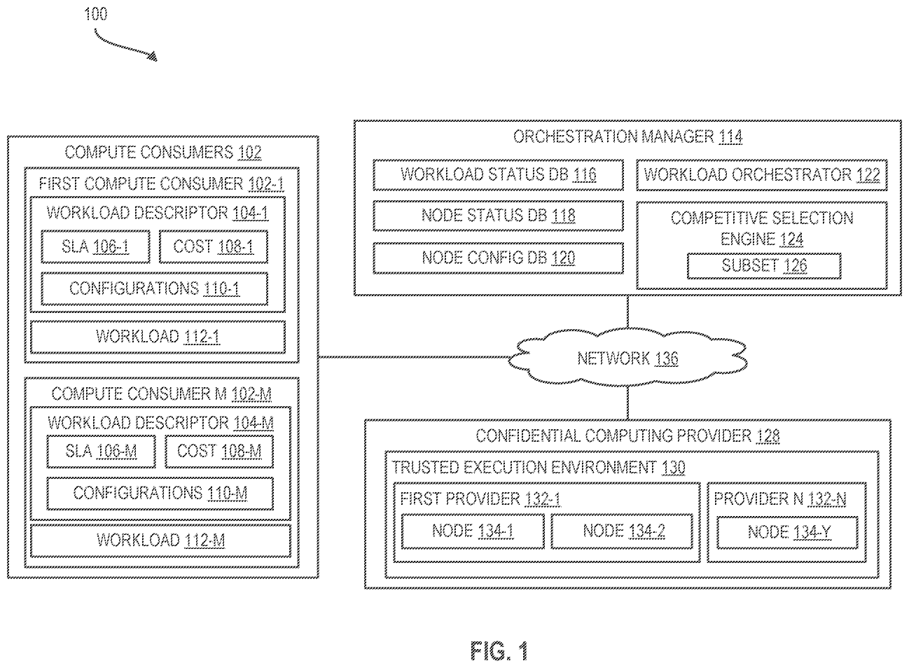

Referring now to the figures, FIG. 1 illustrates a block diagram of an example distributed multi-party grid infrastructure 100 configured to provide self-serve compute infrastructure for secure and confidential workload execution, in accordance with some embodiments of the present disclosure. The distributed multi-party grid infrastructure 100 includes a plurality of compute consumers 102 communicatively coupled to an orchestration manager 114 and a confidential computing provide 128 by a network 136. The network 136 can be a local area network (LAN), a wide area network (WAN), an intranet, the Internet, or any other network 136 or group of networks 136 capable of continuously, semi-continuously, or intermittently connecting (directly or indirectly) the aforementioned components together.

The plurality of compute consumers 102 can refer to users, businesses, organizations, or entities having workloads 112 that require vended compute resources to deploy. The plurality of compute consumers can include a first compute consumer 102-1 and a compute consumer M 102-M, where M can be any integer representing any number of compute consumers 102 such as several, tens, hundreds, or thousands of compute consumers 102. Each compute consumer 102 can include a workload descriptor 104 and a workload 112. Workload descriptor 104 can include a Service Level Agreement (SLA) 106, a cost 108, and configurations 110. SLA 106 can define required characteristics of the vended compute resources such as availability, reliability, bandwidth, latency, and the like. Cost 108 can be a cost a compute consumer 102 is willing to pay to have the workload 112 deployed. Configurations 110 can refer to deployment characteristics of the workload 112 such as, for example, placement (e.g., distance between workloads), priority, and the like. Workload descriptor 104 can implement the aforementioned information as a pre-built artifact or source code (e.g., from a source code repository).

Each compute consumer 102 can include the aforementioned components. For example, first compute consumer 102-1 includes workload descriptor 104-1 having SLA 106-1, cost 108-1, and configuration 110-1 associated with workload 112-1. Likewise, compute consumer 102-M includes workload descriptor 104-M having SLA 106-M, cost 108-M, and configurations 110-M associated with workload 112-M.

Workload 112 can include, for example, business logic, databases and/or database instructions, messages and/or message queues, or any other workload configured to be deployed in a cloud environment.

Confidential computing provider 128 implements a Trusted Execution Environment (TEE) 130. TEE 130 can provide a substrate for confidential computing amongst otherwise untrusted nodes 134. TEE 130 can be implemented, at least in part, by one or more SSCs, for example. In some embodiments, TEE 130 protects data in-flight, at-rest, and in-use. TEE 130 can be implemented across a plurality of providers 132.

Providers 132 can refer to individuals, companies, organizations, or other entities having excess compute resources that can be vended to the multi-party grid infrastructure 100.

For example, the confidential computing provider 128 includes first provider 132-1 to provider N 132-N where N can be any integer representing several, tens, hundreds, or thousands of providers 132. Each provider 132 can be associated with one or more nodes 134. For example, first provider 132-1 is associated with node 134-1 and node 134-2. Similarly, provider N 132-N is associated with node 134-Y, where Y can be any integer representing several, tens, hundreds, thousands, or millions of nodes 134. As shown in FIG. 1, different providers 132 can have different numbers and/or types of nodes 134. The plurality of nodes 134 can be geographically dispersed. Furthermore, the plurality of nodes 134 can otherwise be referred to as a grid of nodes 134. The plurality of nodes 134 can be capable of vending compute resources such as networking resources, storage resources, memory resources, Central Processing Unit (CPU) resources, Graphics Processing Unit (GPU) resources, and the like.

Orchestration manager 114 includes a workload status database (DB) 116, a node status DB 118, a node configuration DB 120, a workload orchestrator 122, and a competitive selection engine 124. Workload status DB 116 can store statuses of workloads 112, whether unmatched with a node 134, matched with a node 134 but not yet deployed, deployed on a node 134, or successfully deployed and archived. Node status DB 118 can store statuses of nodes 134 such as awaiting a workload, implementing a workload, available, unavailable, and the like.

Node configuration DB 120 can store information regarding characteristics of the individual nodes 134 such as, for example, characteristics of vendable compute resources.

Workload orchestrator 122 can match workloads 112 to available resources in the plurality of nodes 134. For example, workload orchestrator 122 can identify a subset 126 of the plurality of nodes 134 that satisfy a SLA 106 associated with the workload 112, interface with the competitive selection engine 124 to select at least one node 134-1 for deploying the workload 112 that satisfies the SLA 106, and automatically deploy the workload 112 on the at least one node 134-1. In some embodiments, the workload orchestrator 122 additionally verifies that the at least one node 134-1 does, in fact, satisfy the SLA 106 by metering vendable resources of the at least one node 134-1.

The competitive selection engine 124 can implement a bidding/pricing algorithm amongst the subset 126 of the plurality of nodes 134. The bidding/pricing algorithm can take the cost 108 as input (e.g., a baseline, a controlling variable, etc.). The bidding/pricing algorithm can enable respective nodes 134 of the subset 126 to bid on deploying the workload 112 at or under the cost 108. In some embodiments, the bidding/pricing algorithm can generate a suggested, recommended, and/or minimal cost 108 based on information in the workload descriptor 104 and/or the workload 112.

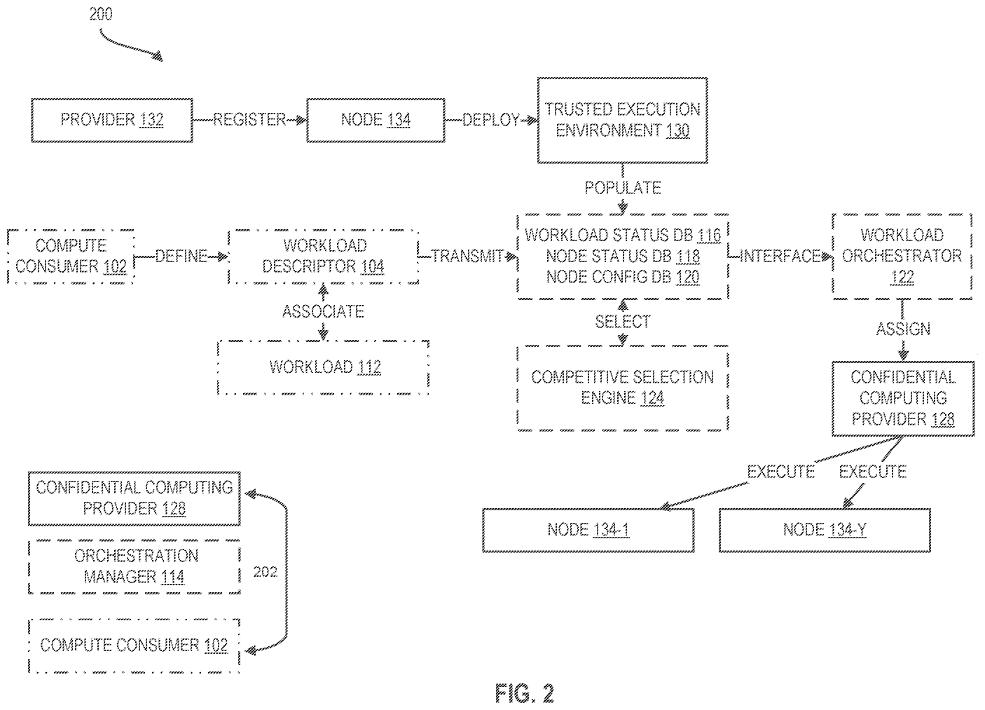

FIG. 2 illustrates a diagram 200 of interactions between various components of the distributed multi-party grid infrastructure 100, in accordance with some embodiments of the present disclosure. Diagram 200 includes a legend 202 detailing various lining patterns and the corresponding high-level component of FIG. 1 such as confidential computing provider 128, orchestration manager 114, and compute consumer 102. In reference to the diagram 200, a provider 132 can register a node 134 to provide vended compute resources to the distributed multi-party grid infrastructure 100. The registered node 134 can be deployed in a trusted execution environment 130. Information about the node (e.g., status, configuration, vendable compute resources, etc.) can be populated into the node status DB 118 and node configuration DB 120.

In parallel (or at different times), a compute consumer 102 can define a workload descriptor 104 associated with a workload 112. The workload descriptor 104 together with the associated workload 112 can be transmitted to the workload status DB 116. The orchestration manager 114 can select a node 134 of the confidential computing provider 128 using the competitive selection engine 124. The orchestration manager 114 can then interface with the workload orchestrator 122 to assign the paired workload 112 and node 134 to the confidential computing provider 128. The confidential computing provider 128 can then execute the workload 112 on the selected node 134, such as node 1 134-1 and/or other nodes such as node Y 134-Y.

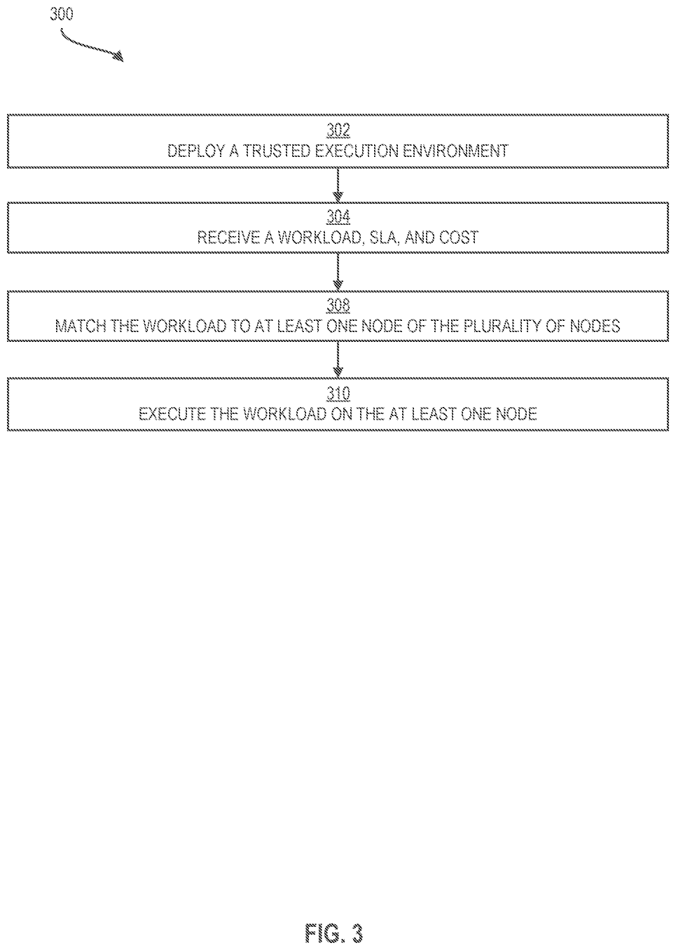

FIG. 3 illustrates a flowchart of an example method 300 for confidential grid computing, in accordance with some embodiments of the present disclosure. The method 300 can be implemented by one or more components of FIG. 1, one or more processors implementing code stored in a computer-readable storage medium (e.g., computer 901 implementing confidential grid computing code 946), or another configuration of hardware and/or software.

The method 300 includes deploying 302 a TEE 130. The TEE 130 can be made up of one or more providers 132 each including one or more nodes 134. The TEE 130 can be configured to provide secure, vendable computing resources from a geographically dispersed, multi-party, compute grid infrastructure to the confidential computing provider 128.

The method 300 further includes receiving 304 a workload 112-1, SLA 106-1, and cost 108-1. The workload 112-1, SLA 106-1, and cost 108-1 can be received from a first compute consumer 102-1.

The method 300 further includes matching 308 the workload 112-1 to at least one node 134-1 of the plurality of nodes 134. The matching 308 can be based on the at least one node 134-1 satisfying the SLA 106-1 and the cost 108-1. In some embodiments, the matching 308 utilizes the competitive selection engine 124.

The method 300 further includes executing 310 the workload 112-1 on the at least one node 134-1. The executing 310 can cause the workload 112-1 to be implemented on the at least one node 134-1, where the at least one node 134-1 implements the workload 112-1 in compliance with the SLA 106-1 and satisfying cost 108-1, thereby providing secure, vendable compute resources via a geographically distributed, multi-party, grid infrastructure.

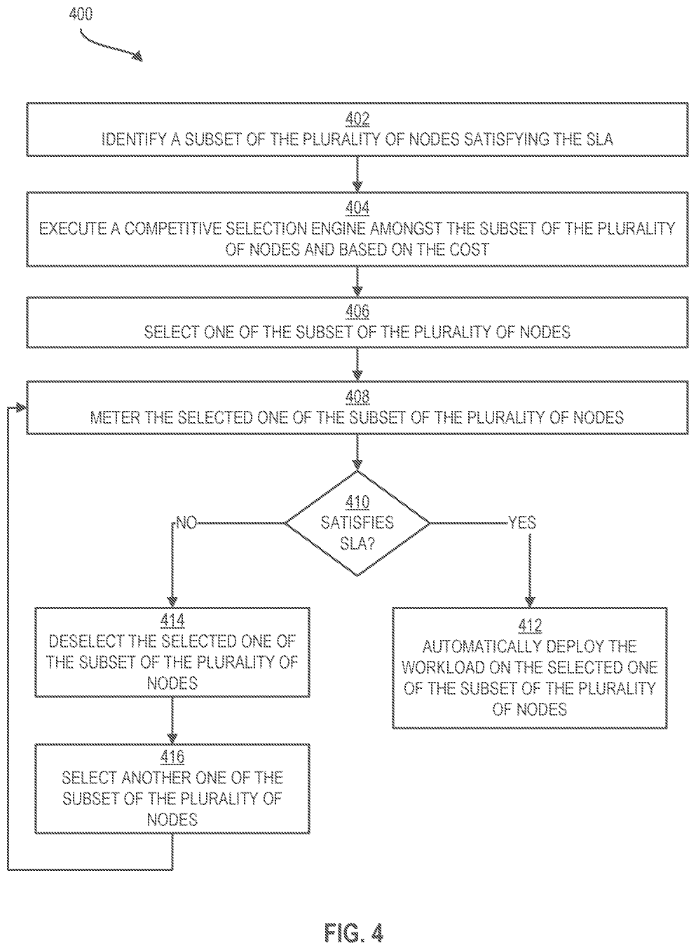

FIG. 4 illustrates a flowchart of an example method 400 for matching a workload 112-1 to at least one node 134-1 in a confidential grid computing environment, in accordance with some embodiments of the present disclosure. The method 400 can be implemented by one or more components of FIG. 1, one or more processors implementing code stored in a computer-readable storage medium (e.g., computer 901 implementing confidential grid computing code 946), or another configuration of hardware and/or software.

The method 400 includes identifying 402 a subset 126 of the plurality of nodes 134 satisfying the SLA 106-1. The identifying 402 can be performed by comparing the requirements of the SLA 106-1 to characteristics of various nodes in the node configuration DB 120.

The method 400 further includes executing 404 a competitive selection engine 124 amongst the subset 126 of the plurality of nodes 134 and based on the cost 108-1.

The method 400 further includes selecting 406 one of the subset 126 of the plurality of nodes 134 based on results from the competitive selection engine 124.

The method 400 further includes metering 408 the selected one of the subset 126 of the plurality of nodes 134. The metering 408 can consume a test amount of vendable compute resources for the selected one of the subset 126 of the plurality of nodes 134 for purposes of measuring the performed of the consumed test amount of vendable compute resources against the SLA 106-1.

The method 400 further includes verifying 410 whether the vended test amount of compute resources satisfies the SLA 106-1. If so (410: YES), the method 400 automatically deploys 412 the workload 112-1 on the selected one of the subset 126 of the plurality of nodes 134. If not (410: NO), the method 400 deselects 414 the selected one of the subset 126 of the plurality of nodes 134 and selects 416 a new one of the subset 126 of the plurality of nodes 134. The selecting 416 can iterate to a next most competitive bid for a node 134 to execute the workload 112-1. The method 400 can subsequently return to meter 408 the new one of the subset 126 of the plurality of nodes 134.

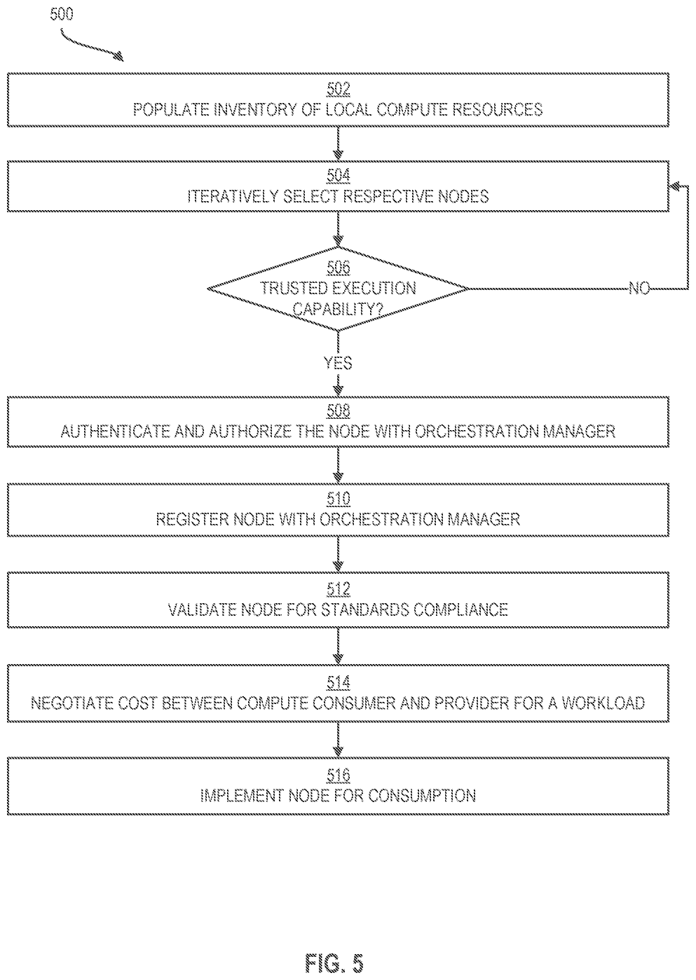

FIG. 5 illustrates a flowchart of an example method 500 for a provider 132 to access and utilize confidential grid computing, in accordance with some embodiments of the present disclosure. The method 500 can be implemented by one or more components of FIG. 1, one or more processors implementing code stored in a computer-readable storage medium (e.g., computer 901 implementing confidential grid computing code 946), or another configuration of hardware and/or software.

The method 500 includes populating 502 an inventory of local compute resources amongst nodes 134 of the provider 132. The populating 502 can include identifying CPU resources, GPU resources, networking resources, storage resources, memory resources, and/or other vendable compute resources of nodes 134 associated with the provider 132.

The method 500 further includes iteratively selecting 504 respective nodes 134 of the provider 132 and determining 506 whether the selected node 134 includes trusted execution capability. Trusted execution capability can refer to interoperability with the trusted execution environment 130, for example. If not (506: NO), the method 500 iteratively selects 504 another node 134. If so (506: YES), the method 500 authenticates and authorizes 508 the node 134 with the orchestration manager 114. The method 500 then registers 510 the node 134 with the orchestration manager by, for example, populating characteristics and/or features of the node 134 to the node status DB 118 and/or the node configuration DB 120.

The method 500 then validates 512 the node 134 for standards compliance. The validation process can relate to verifying characteristics associated with the node 134, security of the node 134, and the like. The validation process can further include metering a test amount of compute resources from the node 134 to verify compliance with an SLA 106 of a workload 112 and/or verify the accuracy of information in the node status DB 118 and/or the node configuration DB 120. The method 500 can then negotiate 514 a cost 108 between a compute consumer 102 and the provider 132 for implementing a workload 112. The negotiating 514 can utilize a competitive selection engine 124 of the orchestration manager 114. The method 500 can then implement 516 the node 134 for consumption by deploying a workload 112 using resources of the node 134, where the cost 108 can be transferred from the compute consumer 102 to the provider 132 before, during, or after completion of the workload 112.

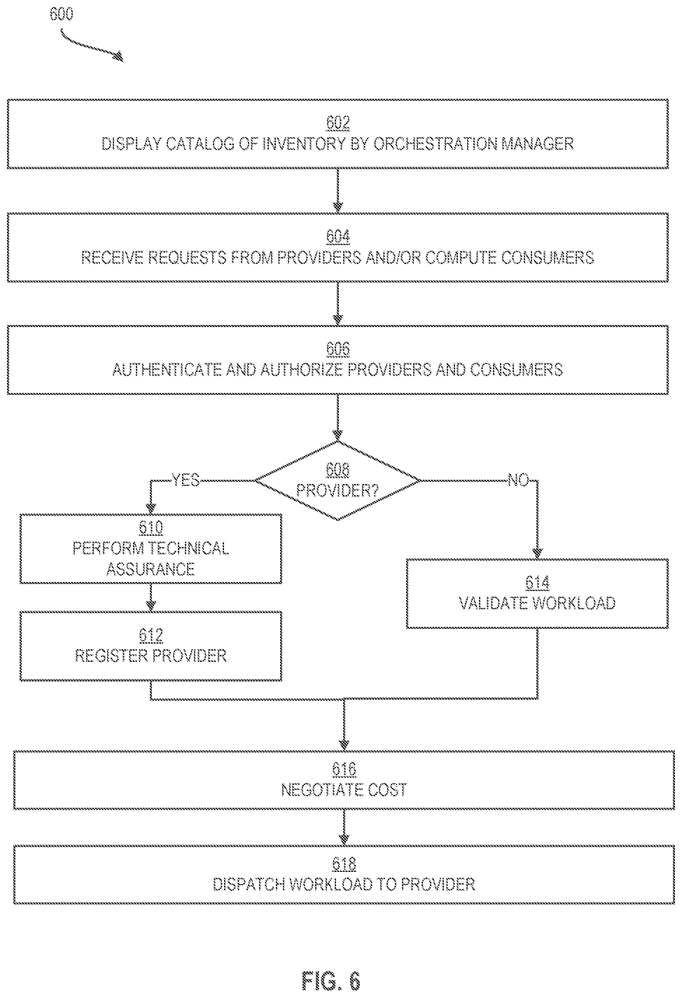

FIG. 6 illustrates a flowchart of an example method 600 for an orchestration manager 114 utilizing confidential grid computing, in accordance with some embodiments of the present disclosure. The method 600 can be implemented by one or more components of FIG. 1, one or more processors implementing code stored in a computer-readable storage medium (e.g., computer 901 implementing confidential grid computing code 946), or another configuration of hardware and/or software.

The method 600 includes displaying 602 a catalog of inventory by the orchestration manager 114. The catalog of inventory can be based on, for example, the node status DB 118 and/or the node configuration DB 120. The method 600 further includes receiving 604, requests from providers 132 (e.g., to register nodes 134) and/or compute consumers 102 (e.g., to deploy workloads 112 using vended resources from the registered nodes 134). The method 600 further includes authenticating and authorizing 606 the providers 132 and the compute consumers 102. The method 600 further includes determining 608 whether the request is received from a provider 132. If not (608: NO), then the request is a workload 112 received from a compute consumer 102 and the method 600 validates 614 the workload 112 for implementation in the confidential computing grid. If so (608: YES), then the method 600 performs 610 technical assurance and registers 612 the provider 132.

The method 600 further negotiates 616 a cost 108 between a compute consumer 102 and a provider 132 for implementing a workload 112 on a node 134. The negotiating can utilize a competitive selection engine 124, for example. The method 600 further dispatches 618 the workload 112 to a selected provider 132 for execution by a node 134.

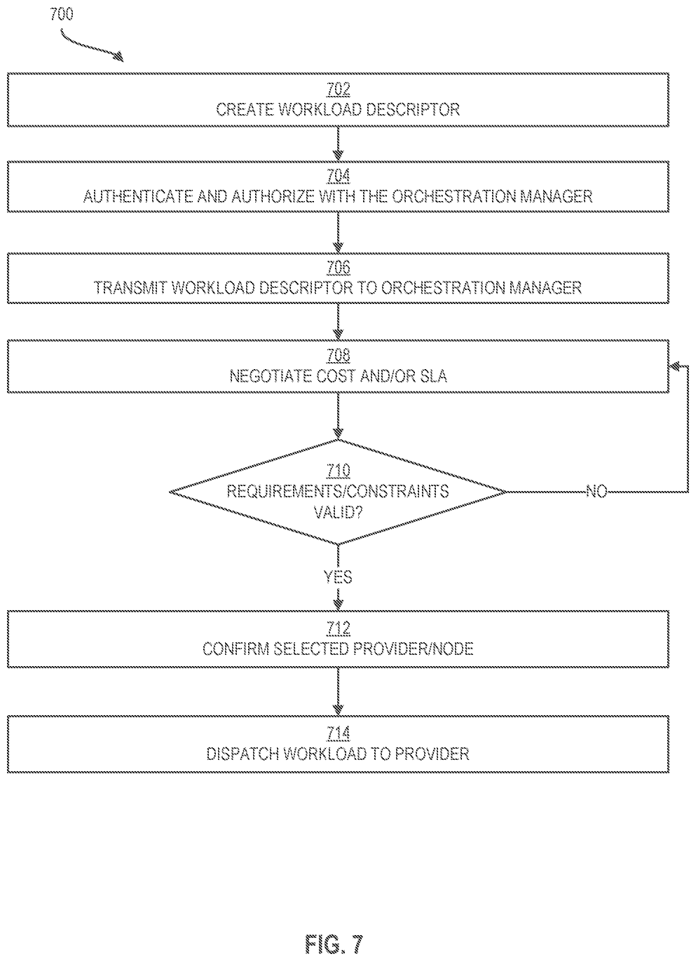

FIG. 7 illustrates a flowchart of an example method 700 for a compute consumer 102 utilizing confidential grid computing, in accordance with some embodiments of the present disclosure. The method 700 can be implemented by one or more components of FIG. 1, one or more processors implementing code stored in a computer-readable storage medium (e.g., computer 901 implementing confidential grid computing code 946), or another configuration of hardware and/or software.

The method 700 includes creating 702 a workload descriptor 104 associated with a workload 112. The creating 702 can include defining a SLA 106, a cost 108, and/or configurations 110 in the workload descriptor 104 and related to the workload 112. The method 700 further includes authenticating and authorizing 704 with the orchestration manager 114. The method 700 further includes transmitting 706 the workload descriptor 104 to the orchestration manager 114. The method 700 further includes negotiating 708 the cost 108 and/or SLA 106 of the workload descriptor. For example, the cost 108 can be negotiated using a competitive selection engine 124. As another example, the SLA 106 can be negotiated based on capabilities of available nodes. The method 700 further includes determining 710 whether the requirements and/or constraints of the workload 112 as defined by the cost 108 and/or the SLA 106 are valid (e.g., executable in the confidential computing grid). If not (710: NO), then the method 700 renegotiates 708 the cost 108 and/or the SLA 106. If so (710: YES), then the method 700 confirms 712 a selected provider 132 and/or node 134 for deploying the workload 112 associated with the workload descriptor 104. The method 700 further includes dispatching 714 the workload 112 to the provider 132 for implementation on one or more nodes 134.

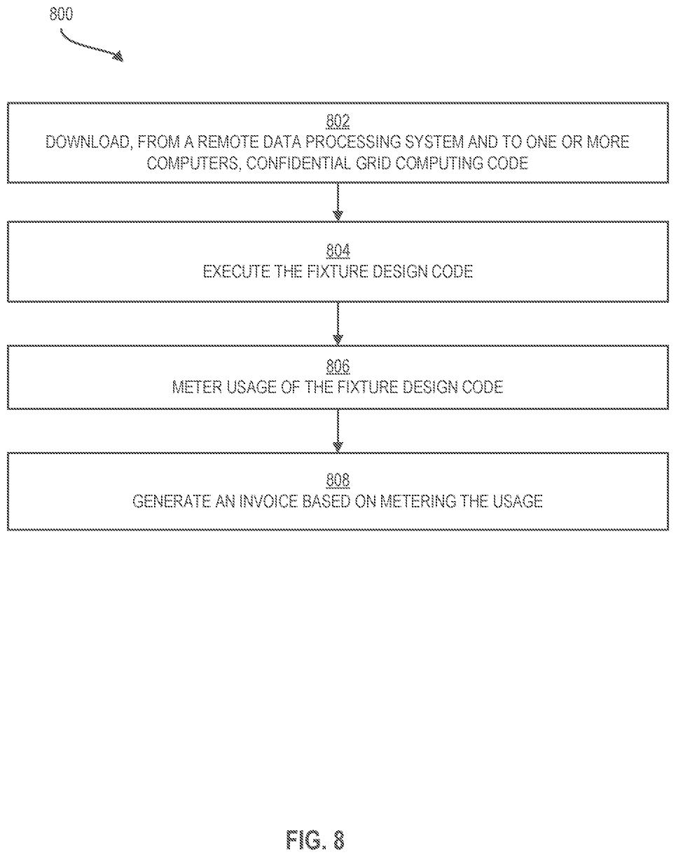

FIG. 8 illustrates a flowchart of an example method 800 for downloading, deploying, metering, and billing usage of confidential grid computing code, in accordance with some embodiments of the present disclosure. The method 800 can be implemented by one or more components of FIG. 1, one or more processors implementing code stored in a computer-readable storage medium (e.g., computer 901 implementing confidential grid computing code 946), or another configuration of hardware and/or software. In some embodiments, the method 800 contemporaneously with any of the aforementioned methods.

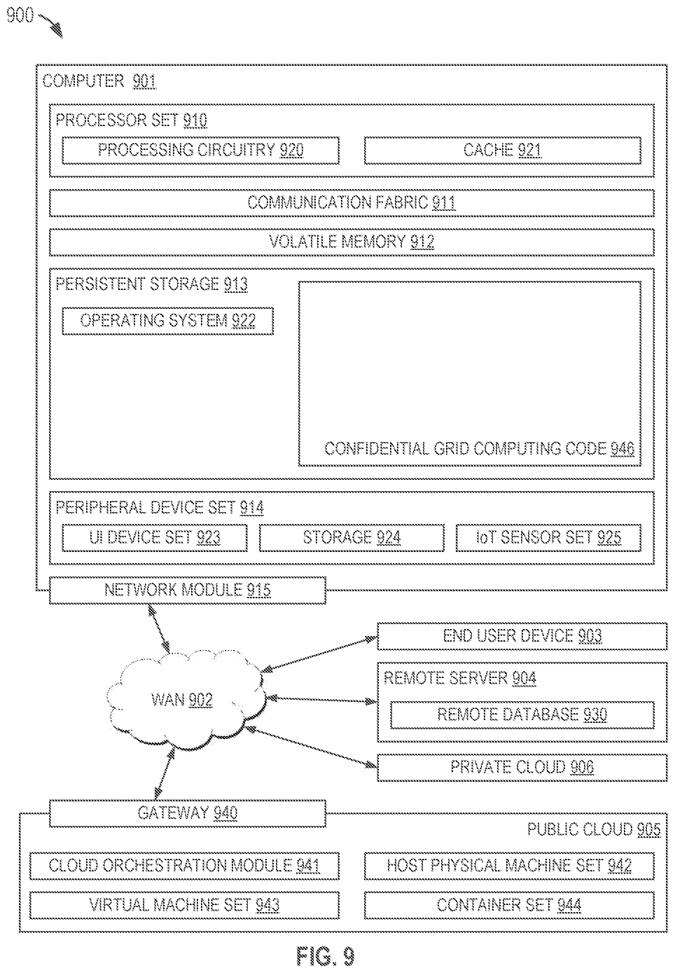

The method 800 includes downloading 802, from a remote data processing system and to one or more computers (e.g., compute consumer 102, confidential computing provider 128, and/or orchestration manager 114 of FIG. 1, computer 901 of FIG. 9, etc.) confidential grid computing code (e.g., confidential grid computing code 946 of FIG. 9). The method 800 further includes executing 804 the confidential grid computing code. The executing 804 can include performing any of the methods and/or functionalities discussed herein. The method 800 further includes metering 806 usage of the confidential grid computing code. Usage can be metered by, for example, an amount of time the confidential grid computing code is used, a number of servers, devices, and/or nodes 134 deploying the confidential grid computing code, an amount of resources consumed by implementing the confidential grid computing code, a number of workloads 112 deployed and/or completed by implementing the confidential grid computing code, and/or other usage metering metrics. The method 800 further includes generating 808 an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 9 illustrates a block diagram of an example computing environment, in accordance with some embodiments of the present disclosure. Computing environment 900 contains an example of an environment for the execution of at least some of the computer code involved in performing the inventive methods, such as confidential grid computing code 946. In addition to confidential grid computing code 946, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and confidential grid computing code 946, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in confidential grid computing code 946 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in confidential grid computing code 946 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902.

Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A system comprising:
a confidential computing provider comprising a geographically dispersed grid of nodes implemented in a trusted execution environment;
a plurality of compute consumers including a first compute consumer comprising a workload configured to run on a cloud computing environment, a Service Level Agreement (SLA), and a cost; and
an orchestration manager communicatively coupling the confidential computing provider with the plurality of compute consumers, wherein the orchestration manager is configured to deploy the workload of the first compute consumer on at least one node of the confidential computing provider that satisfies at least the SLA and the cost.

2. The system of claim 1, wherein respective nodes of the geographically dispersed grid of nodes are individually untrusted, and wherein the workload is securely deployed on the at least one node of the confidential computing provider using the trusted execution environment.

3. The system of claim 1, wherein the trusted execution environment is implemented at least in part by one or more Secure Services Containers (SSCs).

4. The system of claim 1, wherein vendable compute resources provided by the geographically dispersed grid of nodes are protected in-flight, at-rest, and in-use by the trusted execution environment.

5. The system of claim 1, wherein the trusted execution environment further comprises Trusted Platform Module (TPM) attestation protocols implemented amongst the geographically dispersed grid of nodes.

6. The system of claim 1, wherein the orchestration manager further comprises one or more computer-readable storage media collectively storing computer-executable program code configured to cause the orchestration manager to:
identify a subset of the geographically dispersed grid of nodes satisfying the SLA;
execute a competitive selection engine amongst the subset of the geographically dispersed grid of nodes and based on the cost; and
select one of the subset of the geographically dispersed grid of nodes based on the competitive selection engine.

7. The system of claim 6, wherein the orchestration manager comprises additional computer-executable program code stored in the one or more computer-readable storage media and configured to cause the orchestration manager to:
meter the selected one of the subset of the geographically dispersed grid of nodes; and
verify whether the selected one of the subset of the geographically dispersed grid of nodes satisfies the SLA based on the metering.

8. The system of claim 7, wherein the orchestration manager comprises additional computer-executable program code stored in the one or more computer-readable storage media and configured to cause the orchestration manager to:
determine that the selected one of the subset of the geographically dispersed grid of nodes satisfies the SLA based on the metering; and
automatically deploy the workload on the selected one of the subset of the geographically dispersed grid of nodes.

9. The system of claim 7, wherein the orchestration manager comprises additional computer-executable program code stored in the one or more computer-readable storage media and configured to cause the orchestration manager to:
determine that the selected one of the subset of the geographically dispersed grid of nodes fails to satisfy the SLA based on the metering;
deselect the selected one of the subset of the geographically dispersed grid of nodes; and
select another one of the subset of the geographically dispersed grid of nodes.

10. A computer-implemented method comprising:
deploying a Trusted Execution Environment comprising a plurality of nodes in a distributed multi-party grid infrastructure and configured to provide self-serve compute infrastructure for secure and confidential workload execution;
receiving a workload configured to run on a cloud computing environment, a Service Level Agreement (SLA) defining resource characteristics associated with execution of the workload, and a cost associated with executing the workload;
matching the workload to at least one node of the plurality of nodes satisfying the SLA and the cost; and
executing the workload on the at least one node of the plurality of nodes.

11. The method of claim 10, wherein respective nodes of the plurality of nodes are individually untrusted, and wherein the workload is securely deployed on the at least one node using the trusted execution environment.

12. The method of claim 10, wherein the trusted execution environment is implemented at least in part by one or more Secure Services Containers (SSCs).

13. The method of claim 10, wherein vendable compute resources provided by the plurality of nodes are protected in-flight, at-rest, and in-use by the trusted execution environment.

14. The method of claim 10, wherein the trusted execution environment further comprises Trusted Platform Module (TPM) attestation protocols implemented amongst the plurality of nodes.

15. The method of claim 10, wherein matching the workload to the at least one node of the plurality of nodes further comprises:
identifying a subset of the plurality of nodes satisfying the SLA;
executing a competitive selection engine amongst the subset of the plurality of nodes and based on the cost; and
selecting one of the subset of the plurality of nodes based on the competitive selection engine.

16. The method of claim 15, wherein matching the workload to the at least one node of the plurality of nodes further comprises:
metering the selected one of the subset of the plurality of nodes; and
verifying whether the selected one of the subset of the plurality of nodes satisfies the SLA based on the metering.

17. The method of claim 16, wherein matching the workload to the at least one node of the plurality of nodes further comprises:
determining that the selected one of the subset of the plurality of nodes satisfies the SLA based on the metering; and
automatically deploying the workload on the selected one of the subset of the plurality of nodes.

18. The method of claim 16, wherein matching the workload to the at least one node of the plurality of nodes further comprises:
determining that the selected one of the plurality of nodes fails to satisfy the SLA based on the metering;
deselecting the selected one of the subset of the plurality of nodes; and
selecting a new one of the subset of the plurality of nodes.

19. The method of claim 10, wherein the method is executed by one or more data processing systems based on computer-readable program code downloaded to the one or more data processing systems from a remote data processing system, and wherein the method further comprises:
metering usage of the computer-readable program code; and
generating an invoice based on metering the usage of the computer-readable program code.

20. A computer program product comprising one or more computer readable storage media, and program instructions collectively stored on the one or more computer readable storage media, the program instructions comprising instructions configured to cause one or more processors to perform a method comprising:
deploying a Trusted Execution Environment comprising a plurality of nodes in a distributed multi-party grid infrastructure and configured to provide self-serve compute infrastructure for secure and confidential workload execution;
receiving a workload configured to run on a cloud computing environment, a Service Level Agreement (SLA) defining resource characteristics associated with execution of the workload, and a cost associated with executing the workload;
matching the workload to at least one node of the plurality of nodes satisfying the SLA and the cost; and
executing the workload on the at least one node of the plurality of nodes.
